(19) United States
(12) Patent Application Publication
(10) Pub. No.: US 2007/0020373 A1
(43) Pub. Date: Jan. 25, 2007

(54) Fruit spread

(76) Inventor: Robert Edward Maury, San Quentin, CA (US)

Correspondence Address: Robert E. Maury, E-35900, P.O. Box E35900, San Quentin, CA, 94964, US

(21) Appl. No.: 11/188,245

(22) Filed: Jul. 25, 2005

(51) Int. Cl. A23L 1/212

(52) U.S. Cl. 426/615

(57) ABSTRACT

A commercially produceable fruit spread admixture using at least one type of dehydrated preserved fruit powder admixed with or without one or more types of preserved fruit pieces. The admixture is combined with peanut butter, almond butter, or a similar binder substance; a fruit-softener; and optionally flavoring, coloring, preservatives, thickeners, etc., to produce a product that does not require refrigeration; and that can be stored at room temperature without having the fruit spoil. Fruit Spread can be easily manufactured in a variety of fruit flavors, textures, and colors, and can be packed into lightweight, convenient to carry containers. Fruit Spread can be made into a healthier reduced-fat, low-sugar version that can also be produced without the use of peanut products, for people allergic to peanut butter products. Use Fruit Spread as a regular spread, a topping for ice cream and cakes, or as a flavoring for milk.

### CROSS-REFERENCE TO RELATED RESEARCH

NONE.

### FEDERALLY SPONSORED RESEARCH

Not Applicable.

### SEQUENCE LISTING OR PROGRAM

Not Applicable.

### BACKGROUND OF THE INVENTION—FIELD OF INVENTION

This invention relates to a process for combining fruit with peanut butter or a peanut butter that has had all of its fats removed; specifically combining preserved fruit powder and another form of preserved fruit to a binder substance to make a novel fruit spread not seen on store shelves.

### BACKGROUND OF THE INVENTION—PRIOR ART

Peanut butter is boring. Despite the recent addition of jelly into the peanut butter container, the classic peanut butter and the peanut butter sandwich have existed for decades with little change or improvement in flavor, texture, or color. The disadvantages of prior art are:
(a) Currently available peanut butter offers little in the way of a novel taste, texture, or color.
(b) The manufacturer does not add fresh fruit to peanut butter; fresh fruit spoils in the container. To get some variety and novelty, people add fresh bananas to their peanut butter sandwich. As a result, besides purchasing peanut butter, fresh fruit must be purchased separately, carried separately, and added later.
(c) Fresh fruit generally must be cooled or refrigerated; and with a limited shelf life, must be used fairly quickly to prevent spoilage.
(d) Peanut butter and jelly generally have to be purchased in separate containers. Carrying two containers and fresh fruit is inconvenient when picnicking or traveling on trips.
(e) Carrying two containers with the extra: weight and extra space needed is especially inconvenient when backpacking or camping; and there is the mess should jelly spill on things.
(f) Peanut butter is not that healthy. Peanut butter contains a large percentage of calories from fat. One manufacturer indicates: a 2 tablespoon serving has 200 calories; 140 of those calories are from fat; and the recently added jelly uses little fruit, but lots of refined sugar. Parents are concerned about peanut butter with its high fat content and large amount of added refined sugar, especially those parents with obese or diabetic children.
(g) Many people are just allergic to peanut butter.

### BACKGROUND OF THE INVENTION—OBJECTS AND ADVANTAGES

Several objects and advantages of FRUIT SPREAD are:
(a) Fruit Spread offers a way to get novel taste, texture, and color absent in peanut butter. Fruit Spread offers a variety of flavors, which can be natural, or artificially enhanced. Change the preserved fruit used in Fruit Spread and its coarseness and you change the texture. Fruit Spread also offers a variety of inherent colors, which can be further enhanced through the addition of natural or artificial coloring.
(b) Fruit Spread can be made with preserved fruit. Unlike with regular peanut butter, the manufacturer can now put preserved fruit into peanut butter without the risk of spoilage associated with fresh fruit. Peanut butter, fruit, and flavoring can all be carried in one container; everything but the bread is available in one container.
(c) Fruit Spread with its preserved fruit, does not require cooling or refrigeration; and with a long shelf-life can be stored at room temperature and does not have to be used immediately.
(d) Fruit Spread in one container is easy to pack, can be made lightweight, and is easily used to make sandwiches, even while driving on trips.
(e) Fruit Spread saves both weight and space, which is convenient for picnicking, or traveling by vehicle; but is especially convenient when backpacking or camping. Using Fruit Spread eliminates the risk jelly dripping on things like car seats or floor mats.
(f) Fruit Spread is healthier than peanut butter. Fruit Spread made with syrup, instead of oil, has the additional benefit of being lower in fat than equivalent amounts of regular peanut butter, offering a reduced-fat product. Fruit Spread uses natural fruit-sugar as a sweetener, rather than the refined sugar used in jelly. This offers a health benefit over standard peanut butter and jelly. Fruit Spread has the added benefit of being higher in fiber, depending on the preserved fruit used, when compared to regular peanut butter and jelly.
(g) Fruit Spread can be used by those allergic to peanut products when made with almond butter, and vegetable oil or syrup.

### SUMMARY

The object of Fruit Spread is to make a novel product that can be used for numerous purposes, and which can compete with classic peanut butter. Fruit Spread combines preserved fruit, a fruit-softener such as peanut or vegetable oil, or a syrup, with a binder substance such as peanut or almond butter into a single, lightweight container that stores easily without requiring refrigeration.

A second object is for a manufacturer to have a process whereby preserved fruit is added to peanut butter during manufacturing to provide different textures, and novel tastes and coloring which can be naturally occurring, or artificially enhanced.

Another objective is to make a low-fat, low-sugar, healthy fruit product that can be used without refrigeration.

Further objectives of Fruit Spread will appear as the description proceeds.

### DRAWINGS

NONE.

### DETAILED DESCRIPTION

The materials required to make Fruit Spread include:
an edible liquid fruit-softener,
an edible binder substance,
one or more types of preserved fruit powder;
optionally, one or more types of preserved fruit,
and flavoring, coloring, preservatives, salt, etc.
(a) The term “edible liquid fruit-softener” or “fruit-softener” is intended to cover and to include: peanut or almond oil, or another such edible oil such as hydrogenated vegetable oil; maple or corn syrup, or fruit syrup; also fruit juice or water with the appropriate thickeners and preservatives added.
(b) The term “edible binder substance” or “binder substance” is intended to cover and include: “an edible ‘nut butter’ binder substance” such as peanut butter, almond butter, walnut butter, etc., that can be used as a binder substance for the preserved fruit powder and preserved fruit in the Fruit Spread admixture. The ‘nut butter’ binder substance includes any one of the following types of homemade or commercially available peanut or almond butter, etc.: old-fashioned, plain, or crunchy or a product that has had all of its oils and fats removed. The edible binder substance can also be unique to the food processing industry.
(c) The terms “preserved fruit powder” and “preserved fruit” covers and includes fruits that have the water content significantly reduced by some form of dehydration process such as freeze-drying, for fruits such as bananas or raspberries; air-drying, for fruits such as apricots, apples, or raisins; or fruits dehydrated by any dehydration process such as vacuum dehydration that is standard to the food processing industry.

Fruits that do well under dehydration and that can be made into preserved fruit powder and preserved fruit pieces include, but would not be limited to: apples, apricots, bananas, blueberries, coconuts, dates, kiwis, mangoes, papayas, peaches, raisins, raspberries, and strawberries. Any of the types of preserved fruit powder and preserved fruit available can be further combined to produce mixes that would include, but would not be limited to: Banana and Coconut, Banana and Kiwi, Banana and Mango, Strawberry and Kiwi, Strawberry and Papaya, Peach and Strawberry, etc.
(d) Add appropriate flavoring. For commercial production add other flavorings, colorings, preservatives, salt, thickeners, etc., known to those knowledgeable in the art that are used commercially to manufacture food products.
(e) The basic process is to uniformly mix all ingredients by thoroughly stirring the admixture along with the flavors, color dyes, preservatives, and thickeners known to one familiar with the art. Externally heat the admixture to reconstitute both the single preserved fruit powder or the mix of preserved fruit powders and the selected type or types of preserved fruit.

### Preferred Embodiment

The preferred embodiment admixture uses: plain peanut butter for the binder substance, maple syrup or peanut oil for the fruit-softener, freeze-dried banana chips for the preserved fruit powder and for the preserved fruit, and commercially available banana extract for the flavoring.

To make a fixed quantity of Fruit Spread in the preferred “freeze-dried banana chip” embodiment: Use as the binder substance, an amount of plain peanut butter approximately equal to 40% by volume of the total amount of Fruit Spread desired. To this peanut butter binder substance add approximately 30% preserved fruit powder by volume made as follows: Using commercially available or homemade freeze-dried banana chips, or banana chips that have been preserved using any available method, smash the preserved fruit into a powder; or process the preserved fruit into a powder, or very fine granular bits, using any method available. Add the preserved fruit powder or fine granular preserved fruit bits to the peanut butter binder substance.

Add to the binder substance and the previously added preserved fruit powder approximately 15% minced preserved banana chip pieces by volume made as follows: Mince more of the previous preserved banana chips into pieces randomly varying in size between approximately 0.5 mm to approximately 3.5 mm in diameter. This process makes a crunchy type Fruit spread. If a smooth type Fruit Spread is desired omit this step and increase the powdered fruit to 45%. Add the preserved banana pieces to the binder substance and previously powdered or granular preserved banana chips. For improved taste, add the flavoring, in this case, banana extract flavoring, and optionally, natural or artificial coloring, and salt to the mixture to suit the palate.

Finally, add enough peanut oil fruit-softener to this mixture to bring the total volume up to the desired amount; just under 10% peanut oil by volume. For commercial purposes, the best mix of natural and artificial flavoring and coloring to make the product more attractive to the senses could be determined by taste-testing or market surveys. Also the normal mix of salt, sugar, and preservatives used in normal peanut butter manufacturing can be added as required.

While this mixture will gradually reconstitute and soften the preserved fruit without the application of external heat, to hasten the reconstitution process external heat can be applied. Preferably, heat this admixture of peanut butter, powdered and minced banana chips to which peanut oil, coloring, and flavoring, etc. have been added. Use a double-boiler and heat to approximately 65 to 85 degrees Centigrade, or around 150 to 185 degrees Fahrenheit. Allow the minced and preserved powdered banana chips to partially reconstitute under externally applied heat for a time necessary to soften the preserved fruit to the desired crunchiness.

Thoroughly stir the mixture periodically to uniformly blend all ingredients. When the preserved fruit bits are semi-soft, remove the heat source and allow to cool.

Operation

The preferred embodiment, and all below alternative embodiments of Fruit Spread are operated and used in a manner similar to regular peanut butter. The container of Fruit Spread is purchased, taken home, opened, and spread on bread, crackers, etc., just like regular peanut butter. Additionally, Fruit Spread can be warmed and used as a topping on ice cream and cakes, and it can be added to hot or cold milk. Fruit Spread can be packed in jars, plastic containers, etc., just like peanut butter using standard industry practices known to the food processing industry.

### Alternative Embodiments

One alternative embodiment would change the plain peanut butter binder substance to old-fashioned, or crunchy peanut butter with everything else remaining the same as in the preferred embodiment.

Another embodiment would change the ratios of any of the ingredients from those given in the preferred embodiment to any desired ratio, up or down. For example, the amount of the peanut butter binder substance could be increased to 70% of the total volume, and the preserved banana powder could be decreased to 8%, with 12% being minced preserved banana; or any combination. The remaining process of stirring, heating, etc., for producing the final mixture would remain the same as in the preferred embodiment.

Another embodiment would change the preserved fruit type, flavoring, and coloring from that used with the preserved banana embodiment to any of the other preserved fruit types available. For example, dried apples could be used; or freeze-dried apricots, blueberries, etc. Flavor as appropriate. The rest of the procedure for making Fruit Spread is the same as in the preferred embodiment.

Another embodiment would change the single preserved fruit type, the artificial or natural coloring and flavoring to a combination of 2 or more preserved fruit powder and preserved fruits that would be added to the binder substance and fruit-softener. For example, banana and strawberry, banana and apple, etc., can be combined. The preserved banana and strawberry mix would be divided by volume so part of the mix can be powdered and the remaining part would be made into a mince as described above. The ratio of flavoring and the ratio of powder and mince mix could be determined by taste testing. The rest of the procedure is the same as in the preferred embodiment; or any of the other selected embodiments that use a single preserved fruit.

Another embodiment would replace the peanut butter binder substance with another binder substance such as almond butter, walnut butter, macadamia butter, etc. The rest of the process is the same as any other embodiment listed herein that uses a single preserved fruit, or that uses multiple preserved fruits.

Another embodiment would be to replace the peanut oil used in the preferred embodiment with a similar fruit-softener such as hydrogenated vegetable oil, fruit juice, or other similar edible substance standard to the food industry. The rest of the process would be followed with suitable flavorings and coloring adjusted to match the preserved fruit or fruits used.

Another embodiment would replace all oil from the peanut butter and replace it with with maple syrup, corn syrup, or fruit syrup; with appropriate thickeners and preservatives added. This embodiment would have a reduced-fat or no fat content when compared to equivalent amounts of regular peanut butter, or any other like product now on the market, and also a reduced-fat content when compared to equivalent amount of Fruit Spread made with an edible oil.

Another embodiment would replace just the peanut butter and peanut oil used in any other embodiment with almond butter, walnut butter, or macadamia nut butter and any other fruit-softener, other than peanut oil. This embodiment would not cause allergic reactions to those with peanut allergies.

Another embodiment would be to make Fruit Spread using something other than minced preserved fruit. For example, use whole freeze-dried blueberries; or chopped apple slices in place of minced preserved fruit, or any other such size of preserved fruit as appropriate to the fruit type.

Advantages:

From the description above, a number of advantages of Fruit Spread become evident:
(a) Fruit Spread can be manufactured using a wide variety of preserved fruits and flavors. It's also possible to mix and match just about any preserved fruit with any other. It is also possible to adjust the ratio of ingredients, up or down, to suit commercial needs. Fruit Spread can be made in a variety of natural flavors, or even artificially enhanced, thus easily offering a wide range of novel tastes. Fruit Spread offers a variety of textures depending on the preserved fruit used and the coarseness of the preserved fruit pieces. Fruit Spread also offers a variety of color depending on the preserved fruit used and the coloring added; possibilities include blueberry blue, strawberry red, banana yellow, kiwi green, etc.
(b) Fruit Spread can be manufactured as a regular or reduced-fat-content variety, or as a product for those with peanut allergies; also in a variety of fruits and flavors. Fruit Spread that uses maple or corn syrup, or fruit juice instead of peanut or vegetable oil has the additional benefit of being lower in fat than the same amount of regular peanut butter; thus getting a reduced-fat product.
(c) Fruit Spread uses natural fruit-sugars as a sweetener, rather than the refined sugar often used in jellies. This offers a health benefit over standard peanut butter and jelly. Fruit Spread has the added benefit of being higher in fiber, dependent upon the preserved fruit used, when compared to regular peanut butter and jelly.
(d) Fruit Spread contains preserved fruit and a binder substance in one convenient to carry container that can be put into any package or container normally used by the food processing industry to hold regular peanut butter; weight is reduced and space is saved.
(e) The manufacturer can now easily add preserved fruit to the binder substance without the risk of spoilage associated with fresh fruit. Store Fruit Spread at room temperature. No refrigeration is required and it does not have to be used immediately.
(f) Fruit Spread has the added benefit of being made in enhanced colors. Strawberry could be made bright red, blueberry could be made sky blue, and kiwi bright green. This could have appeal to the young and old alike.
   Conclusion, Ramification, Scope

It's time to move peanut butter out of the 19th century and into the 21st. Boring old peanut butter has a competitor, Fruit Spread. Accordingly the reader will see Fruit Spread:
is manufacturable in a wide range of fruit combinations, and in a range of flavors, textures, and colors just by changing the preserved fruit type, fruit-softener, and flavoring;
it can be made as a low-fat product, offering an unique alternative to the high-fat content of peanut butter;
it can have a low-sugar content that is healthier than a peanut butter and jelly sandwich made with refined sugar;
it can be peanut-product-free for those with peanut allergies;
it reduces the risk of fresh fruit spoiling that plagues peanut butter manufacturer;
it not only serves as a spread for bread and crackers, it can also be used to frost cakes or as a topping for ice cream; it can also flavor hot or cold milk.
Currently, no similar products appears on store shelves.

While the above description contains many specificities, these should not be construed as limitations on the scope of the invention, but as exemplifications of the presently preferred embodiments thereof. Many other variations are possible. For example, the ratios of preserved fruits, binder substance, etc., can be changed as desired. It is also possible to change the binder substance.

Thus the scope of the invention should be determined by the appended claims and their legal equivalents, and not by the examples given.

I claim:

1. A fruit spread, comprising an admixture of
an edible fruit-softener, and
an edible binder substance, and
at least one preserved fruit powder, and
at least zero types of preserved fruit; and a means whereby said admixture is thoroughly stirred with flavors, color dyes, preservatives, and thickeners known to one familiar with the art, to uniformly mix the ingredients of said admixture; and said admixture can be heated to reconstitute both said at least one preserved fruit powder and said at least zero types of preserved fruit.

2. The admixture of claim 1, wherein said edible fruit-softener is selected from a group consisting of an edible liquid, an edible oil, an edible syrup, an edible fruit juice, an edible fruit syrup, a nut oil, a peanut oil, an almond oil, a vegetable oil, a maple syrup, a corn syrup, and water.

3. The admixture of claim 1, wherein said edible binder substance is selected from a group consisting of an edible nut butter, a peanut butter, an almond butter, a walnut butter, and a macadamia nut butter.

4. The admixture of claim 1, wherein said at least one preserved fruit powder is made using a type of fruit whose water content has been reduced through a preservation process selected from the group consisting of a dehydration process, freeze-drying, vacuum dehydration, and air-drying; and wherein said type of fruit is selected from the group consisting of edible fruit, apples, apricots, bananas, blueberries, coconuts, dates, kiwis, mangoes, papayas, peaches, raisins, raspberries, and strawberries.

5. The admixture of claim 4, wherein said at least one preserved fruit powder is made using a plurality of said type of fruit.

6. The admixture of claim 1, wherein said admixture is made without said at least zero types of preserved fruit.

7. The admixture of claim 1, wherein said at least zero types of preserved fruit is made using a type of fruit whose water content has been reduced through a preservation process selected from the group consisting of a dehydration process, freeze-drying, vacuum dehydration, and air-drying; and wherein said type of fruit is selected from the group consisting of edible fruit, apples, apricots, bananas, blueberries, coconuts, dates, kiwis, mangoes, papayas, peaches, raisins, raspberries, and strawberries.

8. The admixture of claim 7, wherein said at least zero types of preserved fruit is made with a plurality of said type of fruit.
